(19) United States
(12) Patent Application Publication
(10) Pub. No.: US 2012/0184150 A1
(43) Pub. Date: Jul. 19, 2012

(54) ELECTRIC CABLE HOLDER AND METHOD FOR CONNECTING THE SAME

(75) Inventor: Tetsuro Takasaki, Makinohara-shi (JP)

(73) Assignee: YAZAKI CORPORATION, Tokyo (JP)

(21) Appl. No.: 13/347,738

(22) Filed: Jan. 11, 2012

(30) Foreign Application Priority Data
Jan. 17, 2011 (JP) 2011-006954

(51) Int. Cl. H01R 24/00; B23P 11/00

(52) U.S. Cl. 439/660; 29/592.1

(57) ABSTRACT

An electric cable holder is provided. A housing includes cable receiving grooves provided in parallel with one peripheral wall portion and press contact terminal receiving grooves provided at opposite ends of the cable receiving grooves of the one peripheral wall portion. A cover includes a substrate portion opposite to the one peripheral wall portion and formed with holes communicating with the press contact terminal receiving grooves, a pair of cover portions erected from opposite ends of the substrate portion, and an open preventing portion connecting the cover portions. The housing is provided with an engaging portion engages with the open preventing portion. When press contact terminals are press-contacted with electric cables and received in the press contact terminal receiving grooves while the open preventing portion is engaged with the engaging portion, an engaging receiving portion is disposed between the open preventing portion and the engaging portion.

The disclosure of Japanese Patent Application No. 2011-006854 filed on Jan. 17, 2011, including specification, drawings and claims is incorporated herein by reference in its entirety.

### BACKGROUND

The invention relates to an electric cable holder having a plurality of electric cables attached thereto and allowing the plurality of electric cables to be connected to a plurality of press contact terminals, and a method for connecting the electric cable holder.

There is known the type of vehicle room lamp for mounting on a vehicle ceiling in related art, in which a bus bar formed by punching and bending a metal sheet is incorporated in a synthetic resin housing (see, for example Patent Document 1). FIG. 11 is a perspective view showing the bus bar of the vehicle room lamp according to the related art.

As shown in FIG. 11, the bus bar 103 is provided with a plurality of press contact portions 104 respectively press-contacted with an electric cable, a pair of part mounting portions 107 for mounting a bulb as a light source, and so on.

Each of the press contact portions 104 is formed by a bottom wall 140 and a pair of press contact blades 141 erected from opposite side edges of the bottom wall 140. The electric cable is press-contacted to the pair of press contact blades 141, thereby be electrically connected to the pair of press contact blades 141.

The vehicle room lamp having the bus bar 103 as described above can be assembled in a following manner. Firstly, the bus bar 103, which is already formed by punching and bending a metal sheet, is incorporated in a housing. Then, a bulb is mounted in the pair of part mounting portions 107. Next, each of a plurality of electrical cables is respectively press-contacted to the plurality of press contact portions 104. Finally, a cover is attached on the housing. Thus, the vehicle room lamp is completely assembled.
Patent Document 1: JP-A-2005-329883

The vehicle room lamp according to the related art as described above has a following problem. Specifically, for the vehicle room lamp, the plurality of electric cables are connected to the plurality of press contact blades 104 by press-contacting each of a plurality of electrical cables to each of the plurality of press contact portions 104, leading to an increase in the number of operating steps for connecting the plurality of electric cables to the plurality of press contact blades 104.

### SUMMARY

It is therefore an object of the present invention to solve the problem as described above. Specifically, the object of the invention is to provide an electric cable holder and a method for connecting the electric cable holder, in which a plurality of electric cables can be concurrently connected to a plurality of press contact terminals, and the number of operating steps of engaging the electric cable holder in the holder receiving portion containing the press contact terminals can be reduced.

According to an aspect of the embodiments of the present invention, there is provided an electric cable holder, comprising: a housing including: a bottom wall portion; a top wall portion opposite to the bottom wall portion; a plurality of peripheral wall portions connecting the bottom wall portion with the top wall portion; a plurality of cable receiving grooves provided in parallel with at least one of the peripheral wall portions and configured to respectively receive each of a plurality of electric cables; and a plurality of press contact terminal receiving grooves each formed into a concave shape, provided at opposite ends of the cable receiving grooves of the one of the peripheral wall portions in a width direction thereof, and configured to respectively receive each of a plurality of press contact terminals which are configured to be press-contacted with the electric cables; and a cover including: a substrate portion opposite to the one of the peripheral wall portions and formed with a plurality of holes communicating with the press contact terminal receiving grooves; and a pair of cover portions erected from opposite ends of the substrate portion in an extending direction of the cable receiving grooves and positioning the housing therebetween, wherein the cover is provided with an open preventing portion connecting the pair of cover portions, wherein the housing is provided with: an arm portion one end of which is fixed to the top wall portion and the other end of which extends along a depth direction of the press contact terminal receiving grooves to form a free end; and an engaging portion projecting from a surface of the arm portion and configured to engage with the open preventing portion when the housing is contained in the cover, and wherein when the press contact terminals are press-contacted with the electric cables and the press contact terminals are received in the press contact terminal receiving grooves while the open preventing portion is engaged with the engaging portion, an engaging receiving portion provided in a holder receiving portion containing the press contact terminals is disposed between the open preventing portion and the engaging portion.

In the above aspects of the embodiments of the present invention, the electric cable holder includes a housing including a bottom wall portion, a top wall portion opposite to the bottom wall portion, and a plurality of peripheral wall portions connecting the bottom wall portion with the top wall portion, a plurality of cable receiving grooves provided in parallel to each other in at least one peripheral wall portion of the plurality of peripheral wall portions and respectively receiving each of a plurality of electric cables, and a plurality of press contact terminal receiving grooves in a concave shape provided on opposite ends in the width direction of the cable receiving grooves of the one peripheral wall portion and respectively receiving each of press contact terminals adapted to be press-contacted with each of the electric cables; and a cover including a substrate portion opposite to the one peripheral wall portion and having a plurality of holes communicating with the press contact terminal receiving grooves, and a pair of cover portions erected from opposite ends of the substrate portion in an extending direction of the cable receiving grooves and positioning the housing therebetween. The cover is provided with an open preventing portion connecting between the pair of cover portions, and the housing is provided with an arm portion and an engaging portion projected from a surface of the arm portion, wherein the engaging portion is engaged with the open preventing portion when the housing is contained in the cover. Also, the engaging portion is engaged in a holder receiving portion containing the press contact terminals. Therefore; the electric cable holder and the method for connecting the electric cable holder can be provided, in which, by a simple operation that approaches the substrate portion to the press contact terminals contained in the holder receiving portion, the plurality of press contact terminals can be concurrently connected to the plurality of electric cables, and the number of operating steps of engaging the electric cable holder in the holder receiving portion containing the press contact terminals can be reduced.

The open preventing portion engaged with the engaging portion provided on the housing connects between the pair of cover portions. Therefore, even when the plurality of electric cables are pulled in a direction that separates the pair of cover portions from each other, the pair of cover portions can be prevented from being opened in the direction that separates the pair of cover portions from each other.

The housing and the cover may be integrally formed, with a hinge portion made of flexible resin interposed therebetween, one end of the hinge portion may connect ends of the pair of cover portions, apart from the opening preventing portion, and the other end of the hinge portion may be continued from the bottom wall portion.

With this configuration, the housing and the cover are integrally formed, with a hinge portion made of a flexible resin interposed therebetween. One end of the hinge portion connects between ends of the pair of cover portions apart from the opening preventing portion, and the other end of the hinge portion is connected to the bottom wall portion. Therefore, the efficiency of the assembling operation is enhanced, and the strength of the cover is increased without increasing of the number of parts.

Because the one end of the hinge portion connects between ends of the pair of cover portions apart from the opening preventing portion, even when the plurality of electric cables are pulled in a direction that separates the pair of cover portions from each other, the pair of cover portions can be more securely prevented from being opened in the direction that separates the pair of cover portions from each other.

The electric cable holder may further comprise: an erected portion outwardly erected from another of the peripheral wall portions, which is adjacent to the one of the peripheral wall portions; and an opposing portion continued from the erected portion and configured to position the cover portions between the another of the peripheral wall portions and the opposing portion.

With this configuration, the electric cable holder includes an erected portion outwardly erected from other peripheral wall portion adjacent to the one peripheral wall portion of the plurality of peripheral wall portions, and an opposing portion continued from the erected portion and interposing each of the cover portions between the other peripheral wall portion and the opposing portion. Therefore, even when the plurality of electric cables are pulled in a direction that separates the pair of cover portions from each other, the pair of cover portions can be further securely prevented from being opened in the direction that separates the pair of cover portions from each other.

According to another aspect of the embodiments of the present invention, there is provided a method for connecting the electric cable holder described above, comprising: a first step of receiving the electric cables in the cable receiving grooves, respectively; a second step of receiving the housing in the cover so as to sandwich the electric cables between the housing and the cover in a state where the electric cables are received in the cable receiving grooves, respectively; in a state where the housing is received in the cover, approaching the substrate portion to the press contact terminals, press-contacting the press contact terminals with the electric cables to connect the electric cables to the press contact terminals, and then receiving the press contact terminals in the press contact terminal receiving grooves; and a third step of disposing the engaging receiving portion between the open preventing portion and the engaging portion.

### BRIEF DESCRIPTION OF THE DRAWINGS

In the accompanying drawings:

FIG. 1 is a plan view showing one embodiment of an interior illumination apparatus adapted to mount thereon an electric cable holder according to the invention;

FIG. 2 is a perspective view showing when the electric cable holder of FIG. 1 is placed close to a housing portion of the interior illumination apparatus;

FIG. 3 is an exploded perspective view of the interior illumination apparatus of FIG. 1;

FIG. 4 is a sectional view schematically showing a part of the interior illumination apparatus as taken along line I-I of FIG. 1;

FIG. 5 is a perspective view showing the electric cable holder for the interior illumination apparatus of FIG. 1;

FIG. 6 is a side view of the electric cable holder of FIG. 5;

FIG. 7 is a sectional view taken along line II-II of FIG. 6;

FIG. 8 is an exploded perspective view of the electric cable holder of FIG. 5;

FIGS. 9A to 9D are views showing a process of assembling the electric cable holder of FIG. 8, wherein FIG. 9A is a perspective view showing while electric cables are received in cable receiving grooves of the electric cable holder, FIG. 9B is a perspective view showing when the electric cables have received in the cable receiving grooves, FIG. 9C is a perspective view showing while a housing having the electric cables received in the cable receiving grooves is received in a cover, and FIG. 9D is a perspective view showing when the housing has received in the cover;

FIGS. 10A to 10C are views schematically showing a process of connecting the electric cables attached to the electric cable holder of FIG. 8 with press contact terminals, wherein FIG. 10A is a sectional view showing when the electric cable holder having the electric cables attached thereto is placed close to the press contact terminals, FIG. 10B is a sectional view showing when the electric cables are press-contacted and connected to the press contact terminals, and FIG. 10C is a sectional view showing when the press contact terminals connected to the electric cables are received in the electric cable holder, and the electric cable holder is engaged in an engaging receiving portion of a holder receiving portion; and

FIG. 11 is a perspective view showing a bus bar of a vehicle room lamp according to the related art.

### DETAILED DESCRIPTION OF THE EMBODIMENTS

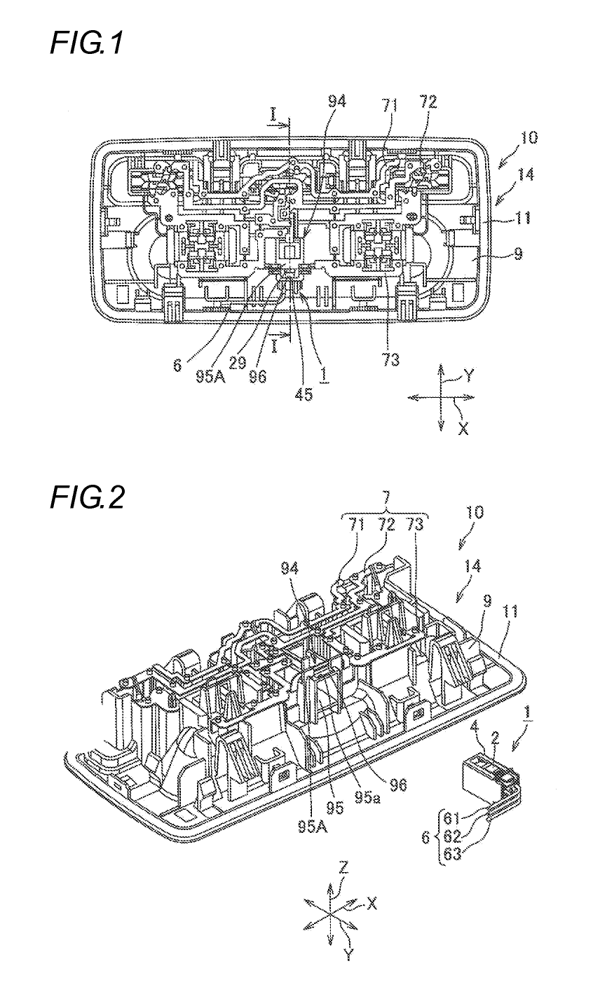

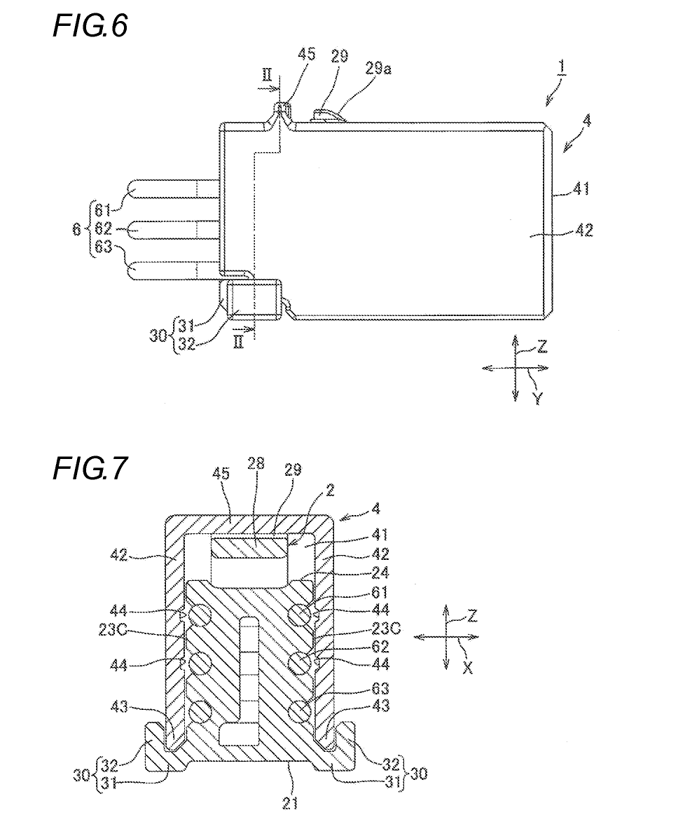

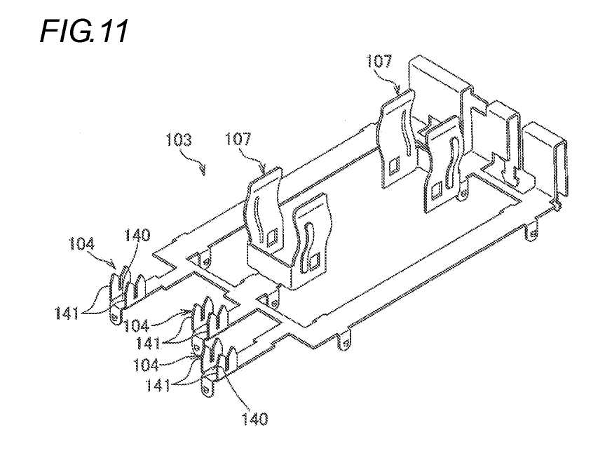

One embodiment of an interior illumination apparatus having an electric cable holder attached thereto according to the invention will now be described in detail with reference to FIGS. 1 to 11. The interior illumination apparatus 10, as shown in FIG. 1 and so on, is mounted to an open window (not shown) provided in a roof trim which is not shown and is disposed in an interior of a motor vehicle as a vehicle (for example, a part or a lining part which is made of a synthetic resin and constitutes a ceiling of the motor vehicle).

The interior illumination apparatus 10 includes a lens portion 11 as a design portion and an illumination unit 14 which has an electric cable holder 1 according to the invention.

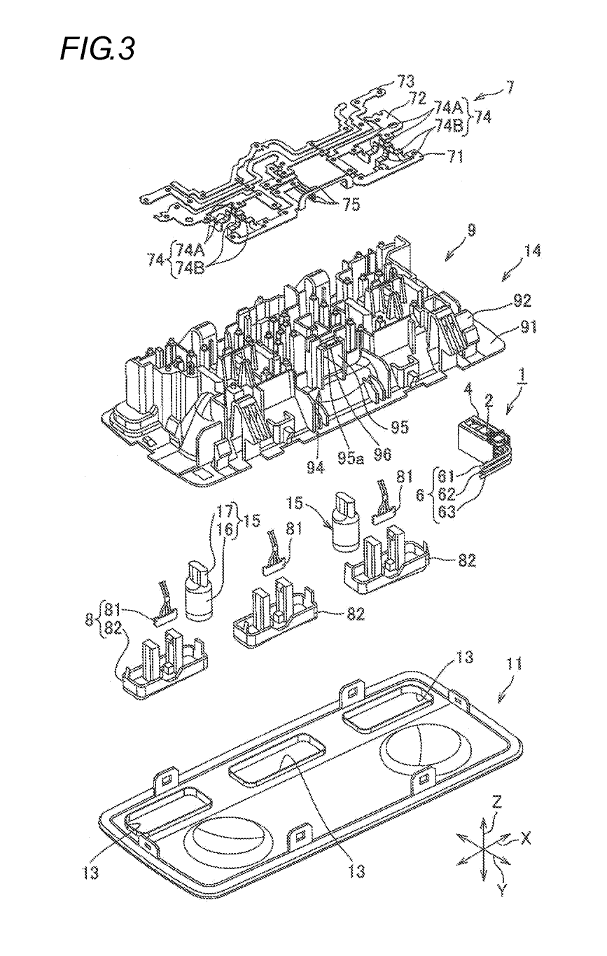

As shown in FIGS. 2 and 3, the lens portion 11 is made of a transparent synthetic resin and is formed in shape of a flat plate. The lens portion 11 is mounted to the open window described above to close the open window. The lens portion 11 is provided with through-holes 13, through which a switch unit 8 of the illumination unit 14 as described below is respectively inserted. The lens portion 11 is adapted to direct a light emitted from the illumination unit 14 to a passenger cabin. The lens portion 11 constitutes the external appearance of the interior illumination apparatus 10.

As shown in FIG. 3, the illumination unit 14 includes a plurality of bulbs 15, an electric cable holder 1 supplying a electric power from a power supply to the plurality of bulbs 15, a bus bar 7 connecting the plurality of bulbs 15 to the electric cable holder 1, a plurality of switch units 8 connected to the bus bar 7 and controlling on/off of the plurality of bulbs 15, and a housing portion 9 made of an electrical insulative synthetic resin and containing the plurality of bulbs 15, the bus bar 7, and the switch units 8.

The plurality of bulbs 15 includes two bulbs. Each of the two bulbs 15 is a known wedge bulb having a light emitting portion 16 for irradiating a light, and a pair of electrodes 17 consisting of a plus electrode and a minus electrode. Alternately, instead of the wedge bulb, a LED wedge bulb may be used in the invention.

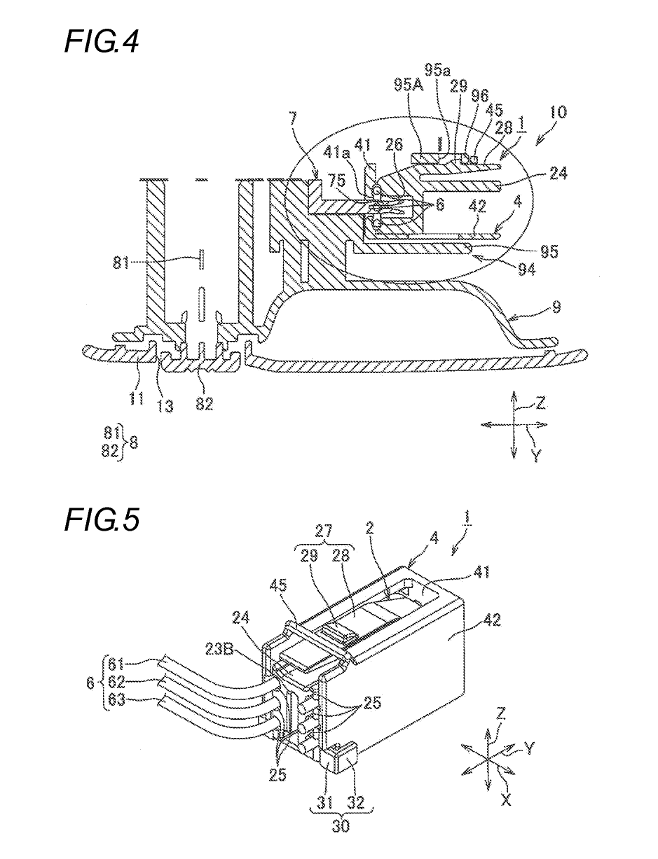

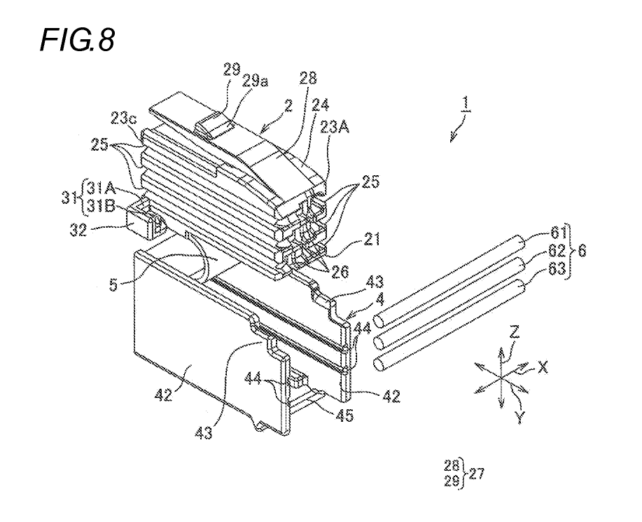

As shown in FIGS. 4, 5, and 6, the electric cable holder 1 includes an inner holder 2 serving as a housing, to which a plurality of electric cables 6 connected to a battery is attached, a cover 4 for containing the inner holder 2, and a hinge portion 5 (shown in FIG. 8) integrally formed with and connecting the inner holder 2 with the cover 4.

The plurality of electric cables 6 include a power supply cable 61 for supplying an electric power from a power supply to the bulb 15, a signal cable 62 for transmitting a control signal from, for example, a controller, and an grounding cable 63.

As shown in FIGS. 7 and 8, the inner holder 2 includes a bottom wall portion 21, a top wall portion 21 opposite to the bottom wall portion 21, and a plurality of peripheral wall portions 23A, 23B (shown in FIG. 5), and 23C connecting the bottom wall portion 21 with the top wall portion 24, thereby forming a rectangular shape. As used in claims, the term “one peripheral wall portion” indicates the peripheral wall portion 24A.

The plurality of peripheral wall portions 23C are provided in a pair. The pair of peripheral wall portions 23C are disposed opposite to each other, and the peripheral wall portion 23A is disposed between the pair of peripheral wall portions 23C. Namely, the pair of peripheral wall portions 23C are disposed on locations close to the peripheral wall portion 23A and indicate “other peripheral wall portion” as used in claims.

The inner holder 2 includes a plurality of cable receiving grooves 25 for respectively receiving each of the plurality of electric cables 6, a plurality of press contact terminal receiving grooves 26 for respectively receiving each of a plurality of press contact terminals 75, as described below, connected to each of the plurality of electric cables 6, an engaging arm 27 adapted to be engaged in an engaging receiving portion 96, as described below, in the housing portion 9, and a plurality of cover inserting portions 30 for inserting the cover 4 therein.

As shown in FIG. 8 and so on, an arrow Y indicates a length direction of the bottom wall portion 21 and the top wall portion 24, and a direction approaching to a holder receiving portion 94, as described below, containing the press contact terminals 75. An arrow X indicates a width direction of the bottom wall portion 21 and the top wall portion 24. The arrows Y and X are perpendicular to each other. An arrow Z is perpendicular to both of the arrows Y and X and indicates a height direction of the inner holder 2.

The plurality of cable receiving grooves 25, as shown in FIG. 8, include three cable receiving grooves formed in parallel to each other along the arrow Z direction. The three cable receiving grooves 25 are formed in a concave shape from surfaces of the pair of peripheral wall portions 23C and the peripheral wall portion 23A. Namely, the cable receiving grooves 25 extend along the length direction (the arrow Y direction) of the peripheral wall portions 23C and the width direction (the arrow X direction) of the peripheral wall portion 23A. Each of the cable receiving grooves 25 receives each of the plurality of electric cables 61, 62, and 63 parallel to each other.

The plurality of press contact terminal receiving grooves 26 are formed in the peripheral wall portion 23A. The plurality of press contact terminal receiving grooves 26 include three press contact terminal receiving grooves in total, provided one by one in each of the cable receiving grooves 25 described above. The three press contact terminal receiving grooves 26 are disposed obliquely relative to the arrow X direction. Each of the press contact terminal receiving grooves 26 is provided on opposite ends in the width direction (the arrow Z direction) of each of the cable receiving grooves 25, and is concavely formed (in a concave shape) from the surface of the peripheral wall portion 23A to receive each of the press contact terminals 75 to be press-contacted respectively to the electric cables 61, 62, and 63.

The engaging arm 27 includes an arm portion 28 formed in shape of a flat plate, in which one end thereof is fixed to an end of the top wall portion 24 adjacent to the peripheral wall portion 23A and the other end extends along the arrow Y (a depth direction of the press contact terminal receiving grooves 26) to form a free end, and an engaging portion 29 projected from a surface of the arm portion 28 and engaged with an open preventing portion 45, as described below, of the cover 4, when the inner holder 2 is contained in the cover 4.

The engaging portion 29 is provided with a tapered portion 29a inclined away from the arm portion 28 from the one end to the other end.

The plurality of cover inserting portions 30 include two cover inserting portions. Each of the two cover inserting portions 30 is outwardly projected from each of the pair of peripheral wall portions 23C. Each of cover inserting portions 30 is formed in a corner of each of the pair of peripheral wall portions 23C adjacent to the bottom wall portion 21 and toward the other end described above. Each of cover inserting portions 30 includes an erected portion 31 erected from a respective peripheral wall portion 23C in the arrow X direction, and an opposing portion 32 continued from the erected portion 31 and opposing to the respective peripheral wall portion 23C.

The erected portion 31 includes a first erected portion 31A parallel to each of the peripheral wall portions 23C, and a second erected portion 31B parallel to the bottom wall portion 21 and the top portion wall 24, thereby forming an L-shape.

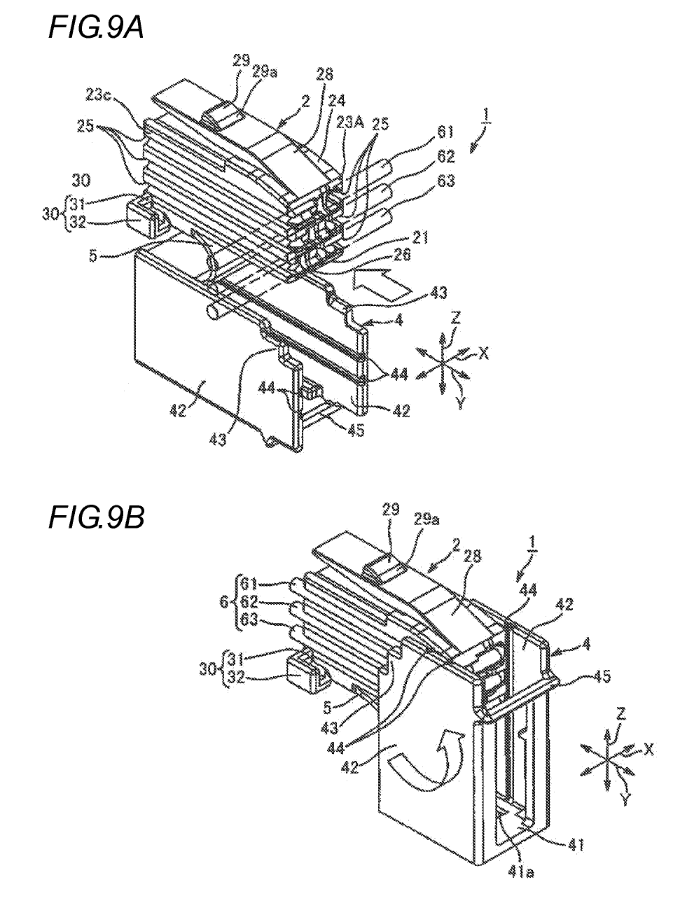

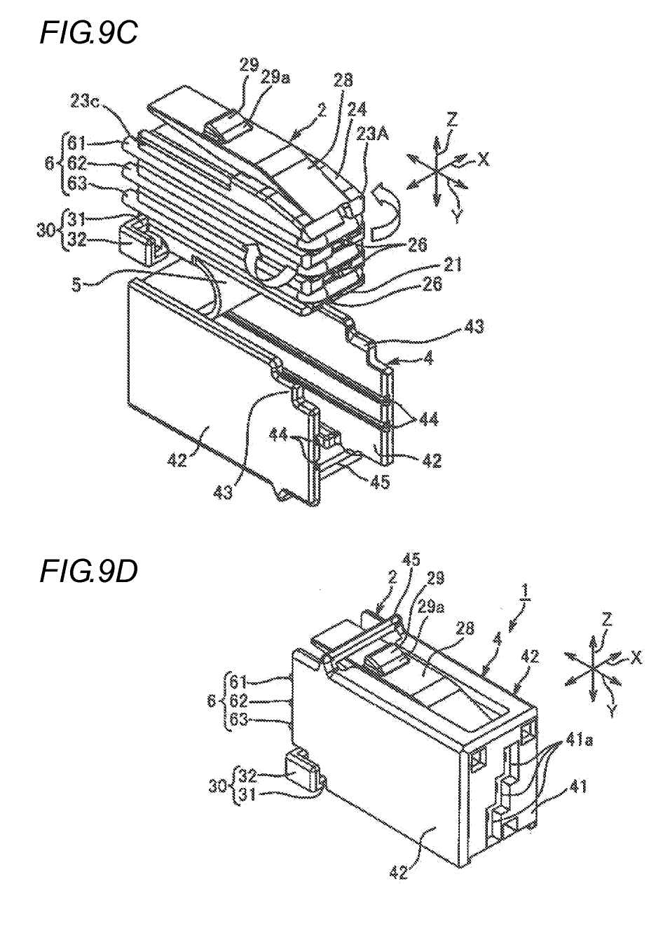

As shown in FIGS. 9C and 9D, the cover 4 includes a substrate portion 41 opposite to the peripheral wall portion 23A, a pair of cover portions 42 erected from opposite ends of the substrate portion 41 in an extending direction (the arrow X direction) of the cable receiving grooves 25 and positioning the inner holder 2 therebetween, and the open preventing portion 45 connecting between the pair of cover portions 42.

The substrate portion 41 includes a plurality of press contact terminal through-holes 41a formed as a hole. The plurality of press contact terminal through-holes 41a are disposed at locations communicating with the press contact terminal receiving grooves 26, when the cover 4 contains the inner holder 2. Each of the press contact terminal through-holes 41a extends through the substrate portion 41.

The pair of cover portions 42 are provided opposite to each other. Each of the pair of cover portions 42 includes an inserting portion 43 inserting in each of the cover inserting portions 30 of the inner holder 2, and a plurality of grooves 44.

As shown in FIG. 9B, the inserting portions 43 are provided in ends of the cover portions 42 adjacent to the hinge portion 5 and away from the substrate portion 41 in the arrow Y direction. The inserting portions 43 are provided by forming L-shaped notches in edges of the cover portions 42 away from the substrate portion 41 in the arrow Y direction and edges of the cover portions 42 adjacent to the hinge portion 5.

The plurality of grooves 44 are disposed opposite to two electric cable receiving grooves 25 adjacent to the top wall portion 24 among the three electric cable receiving grooves 25 described above, when the cover 4 contains the inner holder 2. Each of the plurality of grooves 44 are concavely formed from an inner surface of the cover portions 42.

The open preventing portion 45 is provided on ends of the cover portions 42 away from the hinge portion 5 in the arrow Z direction and away from the substrate portion 41 in the arrow Y direction. Namely, the open preventing portion 45 is provided on ends of the cover portions 42 away from the inserting portions 43 described above in the arrow Z direction. As shown in FIG. 9D, the open preventing portion 45 is provided closer to the other end than the engaging portion 29 in the arrow Y direction, when the cover 4 contains the inner holder 2. If the cover 4 contains the inner holder 2, an engaging receiving portion 96 of the holder receiving portion 94, as described below, is disposed between the open preventing portion 45 and the engaging portion 29, and engaged to the engaging portion 29.

The hinge portion 5 is made of a flexible resin. As shown in FIG. 9B, one end of the hinge portion 5 connects between ends of the pair of cover portions 42 adjacent to the substrate portion 41 in the arrow Y direction and away from the open preventing portion 45 in the arrow Z direction, and the other end thereof is connected to the bottom wall portion 21.

The bus bar 7, as shown in FIG. 3, is formed by punching and bending an electrical conductive metal sheet. The bus bar 7 includes a power supply bus bar 71 connected to the power supply cable 61, a signal bus bar 72 connected to the signal cable 62, and an grounding bus bar 73 connected to the grounding cable 63. The power supply bus bar 71 and the grounding bus bar 73 are spaced to each other.

The bus bar 7 includes a plurality of electrode connecting portions 74 connected respectively to the plurality of bulbs 15 described above, a plurality of press contact terminals 75 connected respectively to the three electric cables and serving as a cable connecting portion, and a plurality of switch connecting portions (not shown) connected respectively to the switch units 8 as described below.

In the example shown, the plurality of electrode connecting portions 74 includes two electrode connecting portions. The two electrode connecting portions 74 are provided on opposite ends of the bus bar 7 in the arrow X direction at a side of one end thereof in the arrow Y direction. Each of the electrode connecting portions 74 is a pair of electrode holding pieces 74A and 74B having a band shape, which are respectively erected from the bus bars 71 and 73 and are spaced opposite to each other. The pair of electrode holding pieces 74A and 74B is upwardly (from below to above in FIG. 2) erected in the arrow Z direction by bending ends of the electrode holding pieces 74A and 74B adjacent to the bus bars 71 and 72. The electrode holding piece 74A is provided in the power supply bus bar 71, and the electrode holding piece 74B is provided in the signal bus bar 72. The electrode holding pieces 74A and 74B are convexly bended close to each other. When the electrodes 17 of the bulbs 15 are inserted between the electrode holding pieces 74A and 74B, the electrode holding piece 74A is connected to a plus electrode of the electrodes 17, and the electrode holding piece 74B is connected to a minus electrode of the electrodes 17.

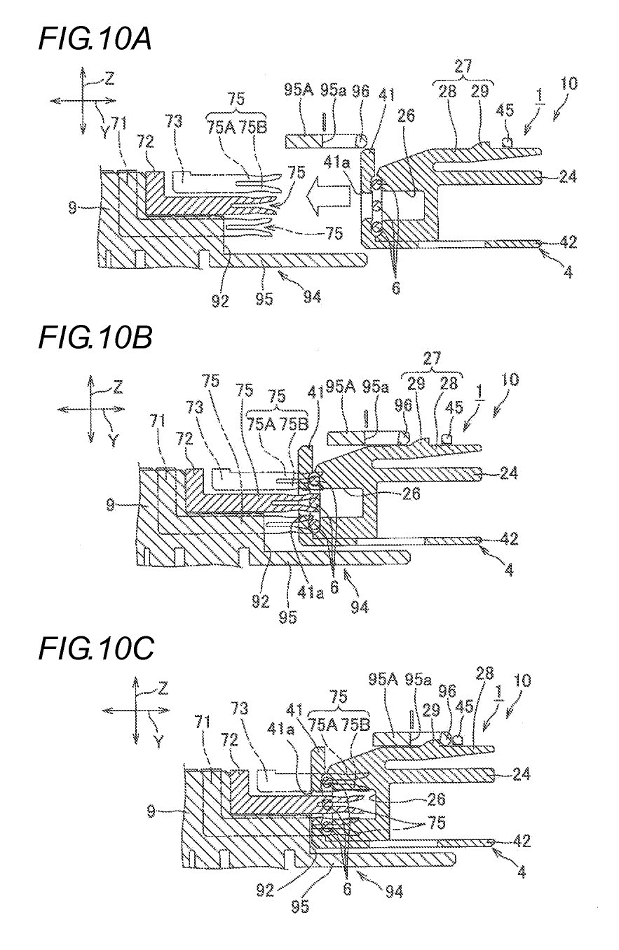

As shown in FIG. 10A and so on, the plurality of press contact terminals 75 include three press contact terminals in the example shown. The three press contact terminals 75 are respectively provided in each of the bus bars 71, 72, and 73. The three press contact terminals 75 are provided between the two electrode connecting portions 74, and arranged side by side in the arrow Z direction.

Each of the press contact terminals 75 includes a pair of press contact blades 75A and 75B opposite to each other. The pair of press contact blades 75A and 75B are spaced to each other along the arrow Z direction, and front ends of the pair of press contact blades 75A and 75B extend toward the electric cable holder 1. Namely, the front ends of press contact blades 75A and 75B extend in the arrow Y direction. When each of the electric cables 61, 62, and 63 described above is pressed in between the pair of the press contact blades 75A and 75B, each of the electric cables 61, 62 and 63 is press-contacted to each of the press contact terminals 75. After each of the electric cables 61, 62 and 63 is press-contacted to each of the press contact terminals 75, the press contact terminals 75 are respectively received in the press contact terminal receiving grooves 26 of the electric cable holder 1.

The plurality of switch connecting portions includes three switch connecting portions in the example shown. The three switch connecting portions are provided at a side of the other end of the bus bar 7 in the arrow Y direction, and are arranged side by side apart from each other in the arrow X direction. The switch connecting portions include a pair of contact receiving portions (not shown) spaced from each other. The pair of contact receiving portions are connected to each other by a contact 81, as described below, of each of the switch units 8. When an actuator (not shown), as described below, of each of the switch units 8 is turned on, the pair of contact receiving portions are connected to each other by the contact 81, thereby forming a closed circuit.

The plurality of switch units 8 include three switch units in the example shown. Each of switch units 8 includes the contact 8 having electrical conduction and connecting between the pair of contact receiving portions described above, and a switch knob 82 having electrical insulation and retaining the contact 8.

The contact 81 is provided between the pair of contact receiving portions, and, when the actuator as described below is turned on or off, electrically connects between the pair of contact receiving portions, or electrically isolates between the pair of contact receiving portions. Thus, according to turn-on/off of the actuator as described below, the contact 81 allows to supply an electric power to the bulbs 15 to turn on the bulbs 15, or to block the electric power supplying to the bulbs 15 to turn off the bulbs 15.

The switch knob 82 is made of an electrical insulative resin, and is disposed in the passenger cabin through the trough-hole 13 of the lens portion 11 described above. The switch knob 82 is provided with the actuator (not shown) to control the turn-on/off of each of the bulb 15 as described above. The actuator can be turned on/off by a passenger.

The housing portion 9 is made of an electrical insulative synthetic resin. The housing portion 9, as shown in FIG. 3, includes a bottom plate 91 parallel to the bus bar 7, and a side plate 92 erected from the perimeters of the bottom plate 91, thereby forming a box shape. The housing portion 9 is provided with a plurality of gaps, and is assembled with the two bulb 15 and the three switch units 8 described above connected to the bus bar 7. The housing portion 9 has the holder receiving portion 94 adapted to be connected with the electric cable holder 1 described above.

The holder receiving portion 94 is provided in a center part of the housing portion 9. The holder receiving portion 94 is formed in a frame shape having an opening to the arrow Y direction (toward the electric cable holder 1). Also, the holder receiving portion 94 has a plurality of peripheral plates 95 erected from the side plate 92 in the arrow Y direction. The electric cable holder 1 can be inserted inside the peripheral plates 95. The press contact terminals 75 described above are contained inside the holder receiving portion 94. The press contact terminals 75 are provided to project from the side plate 92 in the arrow Y direction (toward the electric cable holder 1).

As shown in FIG. 4, the peripheral plates 95 are provided with an overlap plate 95A overlapped with the arm portion 28 of the electric cable holder 1 described above, when the electric cable holder 1 is inserted therein. The overlap plate 95 is provided opposite to the bottom plate 91. The overlap plate 95A is provided with the engaging receiving portion 96 adapted to be engaged with the engaging portion 29 of the electric cable holder 1 described above. The engaging receiving portion 96 is obtained by forming an engaging hole 95a in which the engaging portion 29 of the electric cable holder 1 can be introduced, as the electric cable holder 1 is approached thereto in the arrow Y direction. The engaging hole 95a extends through the overlap plate 95A.

A process of assembling the interior illumination apparatus 10 and a process of connecting the electric cable holder 1 as described above will be now described. The housing portion 9, the bus bar 7, and the switch units 8 connected to the bus bar 7 are integrally molded by an insert molding, and then the electrodes 17 of each of the bulbs 15 are inserted between the pair of the electrode holding pieces 74A and 74B of each of the electrode connecting portions 74 to connect each of the bulbs 15 to the electrode connecting portions 74.

A process of assembling the electric cable holder 1 as described above will be now described with reference to FIG. 9. Firstly, as shown in FIG. 9A, the hinge portion 5 is bended in a U-shape to approach the one end of the hinge portion 5 to the other end and expose the inner holder 2, and then, as shown in FIG. 9B, each of the electric cables 61, 62 and 63 is respectively received in the cable receiving grooves 25 of the inner holder 2 (corresponding to a first step). Then, as shown in FIG. 9C, with each of the electric cables 61, 62, and 63 respectively received in the cable receiving grooves 25, the cover 4 is rotated to return the hinge portion 9 to a state prior to bending of the hinge portion 5. As a result, the open preventing portion 45 is contacted with the engaging portion 29. When the cover 4 is more rotated, the engaging portion 29 is pressed by the open preventing portion 45, such that the arm portion 28 can be bended. By bending the arm portion 28, the open preventing portion 45 rides on the engaging portion 29. When the cover 4 is further rotated, the open preventing portion 45 goes over the engaging portion 29, such that the engaging portion 29 is engaged with the open preventing portion 45. In this time, the open preventing portion 45 is disposed closer to the other end than the engaging portion 29 in the arrow Y direction. As a result, the engaging portion 29 is engaged with the open preventing portion 45, and at the same time, the inserting portions 43 of the cover 4 are inserted in the cover inserting portions 30 of the inner holder 2. Thus, the cover 4 receives the inner holder 2 to sandwich the electric cables 6 in between the inner holder 2 and the cover 4 (corresponding to a second step), and the electric cable holder 1 is completely assembled.

Next, the electric cable holder 1 is approached to the holder receiving portion 94, as shown in FIG. 10A. As a result, the substrate portion 41 of the electric cable holder 1 is disposed close to the plurality of press contact terminals 94 contained in the holder receiving portion 94. When the electric cable holder 1 is more approached, the press contact terminals 75 pass through the press contact terminal through-holes 41a of the substrate portion 41. When the electric cable holder 1 is further approached, as shown in FIG. 10B, each of the electric cables 61, 62, and 63 respectively received in the cable receiving grooves 25 is respectively contacted with the front ends of the plurality of press contact terminals 75 passing through the press contact terminal through-holes 41a, and the tapered portion 29a of the engaging portion 29 is contacted with the engaging receiving portion 96.

When the electric cable holder 1 is further approached while the tapered portion 29a of the engaging portion 29 is contacted with the engaging receiving portion 96, the aim portion 28 is bended close to the top wall portion 24 by the tapered portion 29a, and the engaging receiving portion 96 rides on the engaging portion 29.

When the electric cable holder 1 is further approached, the engaging receiving portion 96 goes over the engaging portion 29, and the engaging portion 29 is introduced into the engaging hole 95a as shown in FIG. 10C. Thus, the engaging portion 29 is engaged in the engaging receiving portion 96. In this time, the engaging receiving portion 96 is disposed between the open preventing portion 45 and the engaging portion 29.

As the engaging portion 29 is engaged in the engaging receiving portion 96, each of the electric cables 61, 62, and 63 respectively received in the cable receiving grooves 25 is pressed in between the pair of press contact blades 75A and 75B. Thus, the plurality of press contact terminals 75 can be concurrently press-contacted with each of the electric cables 61, 62, and 63, such that the plurality of press contact terminals 75 can be respectively connected to each of the electric cables 61, 62, and 63. The plurality of press contact terminals 75 is respectively received in each of the press contact terminal receiving grooves 26 while being press-contacted with each of the electric cables 61, 62, and 63 (corresponding to a third step). Thus, each of the electric cables 61, 62, and 63 attached to the electric cable holder 1 can be connected to the press contact terminals 75 (the bus bar 7).

Then, the illumination unit 14, in which the electric cables 61, 62, and 63 attached to the electric cable holder 1 has respectively connected to the press contact terminals 75 (the bus bar 7), is inserted in the open window provided in the roof trim of the motor vehicle, and then the lens portion 11 is mounted to the open window to close the open window. As a result, the interior illumination apparatus 10 is completely assembled.

According to the embodiments, the electric cable holder 1 includes an inner holder 2 as a housing including a bottom wall portion 21, a top wall portion 21 opposite to the bottom wall portion 21, and a plurality of peripheral wall portions 23A, 23B, and 23C connecting the bottom wall portion 21 to the top wall portion 24, a plurality of cable receiving grooves 25 provided in parallel to each other in at least one peripheral wall portion 23A of the plurality of peripheral wall portions 23A, 23B, and 23C and respectively receiving each of a plurality of electric cables 61, 62, and 63, and a plurality of press contact terminal receiving grooves 26 in a concave shape provided on opposite ends in the width direction (the arrow Z direction) of the cable receiving grooves 25 of the one peripheral wall portion 23A and respectively receiving each of press contact terminals 75 adapted to be press-contacted with each of the electric cables 61, 62, and 63; and a cover 4 including a substrate portion 41 opposite to the one peripheral wall portion 23A and having a plurality of press contact terminal through-holes 41a formed as a hole communicating with the press contact terminal receiving grooves 26, and a pair of cover portions 42 erected from opposite ends of the substrate portion 41 in an extending direction (the arrow X direction) of the cable receiving grooves 25 and positioning the inner holder 2 therebetween. The cover 4 is provided with an open preventing portion 45 connecting between the pair of cover portions 42, and the inner holder 2 is provided with an arm portion 28 and an engaging portion 29 projected from a surface of the arm portion 28, wherein the engaging portion 29 is engaged with the open preventing portion 45 when the inner holder 2 is contained in the cover 4. Also, the engaging portion 29 is engaged in a holder receiving portion 94 containing the press contact terminals 75. Therefore, the electric cable holder 1 and the method for connecting the electric cable holder 1 can be provided, in which, by a simple operation that approaches the substrate portion 41 to the press contact terminals 75 contained in the holder receiving portion 94, the plurality of press contact terminals 75 can be concurrently connected to the plurality of electric cables 61, 62, and 63, and the number of operating steps of engaging the electric cable holder 1 in the holder receiving portion 94 containing the press contact terminals 75 can be reduced.

The open preventing portion 45 engaged with the engaging portion 29 provided on the inner holder 2 connects between the pair of cover portions 42. Therefore, even when the plurality of electric cables 6 are pulled in a direction (the arrow X direction) that separates the pair of cover portions 42 from each other, the pair of cover portions 42 can be prevented from being opened in the direction (the arrow X direction) that separates the pair of cover portions 42 from each other.

The inner holder 2 and the cover 4 are integrally formed, with a hinge portion 5 made of a flexible resin interposed therebetween. One end of the hinge portion 5 connects between ends of the pair of cover portions 42 apart from the opening preventing portion 45, and the other end of the hinge portion 5 is connected to the bottom wall portion 21. Therefore, the efficiency of the assembling operation is enhanced, and the strength of the cover 4 is increased without increasing of the number of parts.

Because the one end of the hinge portion 5 connects between ends of the pair of cover portions 42 apart from the opening preventing portion 45, even when the plurality of electric cables 61, 62, and 63 are pulled in a direction (the arrow X direction) that separates the pair of cover portions 42 from each other, the pair of cover portions 42 can be more securely prevented from being opened in the direction (the arrow X direction) that separates the pair of cover portions 42 from each other.

The electric cable holder 1 includes an erected portion 31 outwardly erected from other peripheral wall portion 23C adjacent to the one peripheral wall portion 23A of the plurality of peripheral wall portions 23A, 23B, and 23C, and an opposing portion 32 continued from the erected portion 31 and interposing each of the cover portions 42 between the other peripheral wall portion 23C and the opposing portion 32. Therefore, even when the plurality of electric cables 61, 62, and 63 are pulled in a direction (the arrow X direction) that separates the pair of cover portions 42 from each other, the pair of cover portions 42 can be further securely prevented from being opened in the direction (the arrow X direction) that separates the pair of cover portions 42 from each other.

According to the embodiments, although the cable receiving grooves 25 is provided in the pair of peripheral wall portions 23C and the peripheral wall portions 23A, the invention is not limited to such a construction, and the cable receiving grooves 25 may be only provided at least the peripheral wall portions 23A.

According to the embodiments, although the erected portion 31 includes the first erected portion 31A parallel to each of the peripheral wall portions 23C, and the second erected portion 31B parallel to the bottom wall portion 21 and the top portion wall 24, the invention is not limited to such a construction, and the erected portion 31 may be provided with at least one of the a the first erected portion 31A and the second erected portion 31B.

The above description of embodiments of the invention is merely exemplary in nature, and thus the present invention is not limited to the above embodiments. Accordingly, suitable modifications can be made without departing from the sprit or scope of the invention.

What is claimed is:

1. An electric cable holder, comprising:
a housing including:
a bottom wall portion;
a top wall portion opposite to the bottom wall portion;
a plurality of peripheral wall portions connecting the bottom wall portion with the top wall portion;
a plurality of cable receiving grooves provided in parallel with at least one of the peripheral wall portions and configured to respectively receive each of a plurality of electric cables; and
a plurality of press contact terminal receiving grooves each formed into a concave shape, provided at opposite ends of the cable receiving grooves of the one of the peripheral wall portions in a width direction thereof, and configured to respectively receive each of a plurality of press contact terminals which are configured to be press-contacted with the electric cables; and
a cover including:
a substrate portion opposite to the one of the peripheral wall portions and formed with a plurality of holes communicating with the press contact terminal receiving grooves; and
a pair of cover portions erected from opposite ends of the substrate portion in an extending direction of the cable receiving grooves and positioning the housing therebetween,
wherein the cover is provided with an open preventing portion connecting the pair of cover portions,
wherein the housing is provided with:
an arm portion one end of which is fixed to the top wall portion and the other end of which extends along a depth direction of the press contact terminal receiving grooves to form a free end; and
an engaging portion projecting from a surface of the arm portion and configured to engage with the open preventing portion when the housing is contained in the cover, and
wherein when the press contact terminals are press-contacted with the electric cables and the press contact terminals are received in the press contact terminal receiving grooves while the open preventing portion is engaged with the engaging portion, an engaging receiving portion provided in a holder receiving portion containing the press contact terminals is disposed between the open preventing portion and the engaging portion.

2. The electric cable holder according to claim 1,
wherein the housing and the cover are integrally formed, with a hinge portion made of flexible resin interposed therebetween,
wherein one end of the hinge portion connects ends of the pair of cover portions, apart from the opening preventing portion, and
wherein the other end of the hinge portion is continued from the bottom wall portion.

3. The electric cable holder according to claim 1, further comprising:
an erected portion outwardly erected from another of the peripheral wall portions, which is adjacent to the one of the peripheral wall portions; and
an opposing portion continued from the erected portion and configured to position the cover portions between the another of the peripheral wall portions and the opposing portion.

4. A method for connecting the electric cable holder according to claim 1, comprising:
a first step of receiving the electric cables in the cable receiving grooves, respectively;
a second step of receiving the housing in the cover so as to sandwich the electric cables between the housing and the cover in a state where the electric cables are received in the cable receiving grooves, respectively;
in a state where the housing is received in the cover, approaching the substrate portion to the press contact terminals, press-contacting the press contact terminals with the electric cables to connect the electric cables to the press contact terminals, and then receiving the press contact terminals in the press contact terminal receiving grooves; and
a third step of disposing the engaging receiving portion between the open preventing portion and the engaging portion.
